(19) United States
(12) Patent Application Publication
(10) Pub. No.: US 2007/0247326 A1
(43) Pub. Date: Oct. 25, 2007

(54) Multimedia video and audio wireless transmitting and receiving device

(76) Inventor: Chung-Hung Lin, Syuejia Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/397,697

(22) Filed: Apr. 5, 2006

(51) Int. Cl. G08C 19/00

(52) U.S. Cl. 340/825.69; 710/303; 725/74; 455/66.1; 455/3.06

(57) ABSTRACT

A wireless transmitting and receiving device includes a transmitting equipment connected with a portable multimedia player, and a receiving equipment connected to a playing unit with a display having larger dimensions than a display of the portable multimedia player; video and audio data in the portable multimedia player will be transmitted by means of a wireless transmitting unit of the transmitting equipment, received by means of a wireless receiving unit of the receiving equipment, and played by means of the playing unit.

### BACKGROUND OF THE INVENTION

1. Field of the Invention

The present invention relates to a multimedia video and audio wireless transmitting and receiving device, more particularly one, which includes a transmitting equipment connected to a portable multimedia player, and a receiving equipment for receiving video and audio signals transmitted from the transmitting equipment; the receiving equipment is connected to a playing unit with a display having larger dimensions than a display of the portable multimedia player; thus, images will be larger and more clearly seen, and can be shared among several persons.

2. Brief Description of the Prior Art

There are many different kinds of devices available for playing music, images, sound etc, e.g. MP3 (MPEG-Movie Picture Experts Group-1 Layer 3) player, MP4 (MPEG-4; Movie Picture Experts Group-4) player, CD (Compact Disk) player, VCD (Video Compact Disk) player, DVD (Digital Versatile/Video Disk) player for meeting people's different needs.

The electronic industry developed portable multimedia players (PMP) for playing music and movies, which have large storage capacity, and are compact and getting more popular.

However, such portable multimedia players are small in size, and have a relatively small display. Consequently, the elderly and poor eye-sighted users will have difficulty seeing the images and letters on the displays clearly. Furthermore, the users have to wear conventional earphones to listen to music played with portable multimedia players, which earphones have cords connected to the multimedia players, and in turn the music can't be shared among several persons. Therefore, it isn't a convenient way to use the portable multimedia players.

### SUMMARY OF THE INVENTION

It is a main object of the invention to provide a multimedia video and audio wireless transmitting and receiving device to overcome the above-mentioned problems.

The multimedia video and audio wireless transmitting and receiving device of the present invention includes a transmitting equipment connected with a portable multimedia player, and a receiving equipment connected to a playing unit, which has a display having larger dimensions than a display of the portable multimedia player. Video and audio data in the portable multimedia player will be transmitted by means of a wireless transmitting unit of the transmitting equipment, received by means of a wireless receiving unit of the receiving equipment, and played through the playing unit. Therefore, the images will be larger and more clearly seen, and can be shared among several persons.

### BRIEF DESCRIPTION OF THE DRAWINGS

The present invention will be better understood by referring to the accompanying drawings, wherein:

FIG. 1 is a perspective view of the present invention,

FIG. 2 is a circuit block diagram of the transmitting equipment of the present invention,

FIG. 3 is a view of the transmitting equipment of the invention,

FIG. 4 is a view of the second preferred embodiment of the transmitting equipment, and

FIG. 5 is a circuit block diagram of the receiving equipment of the present invention.

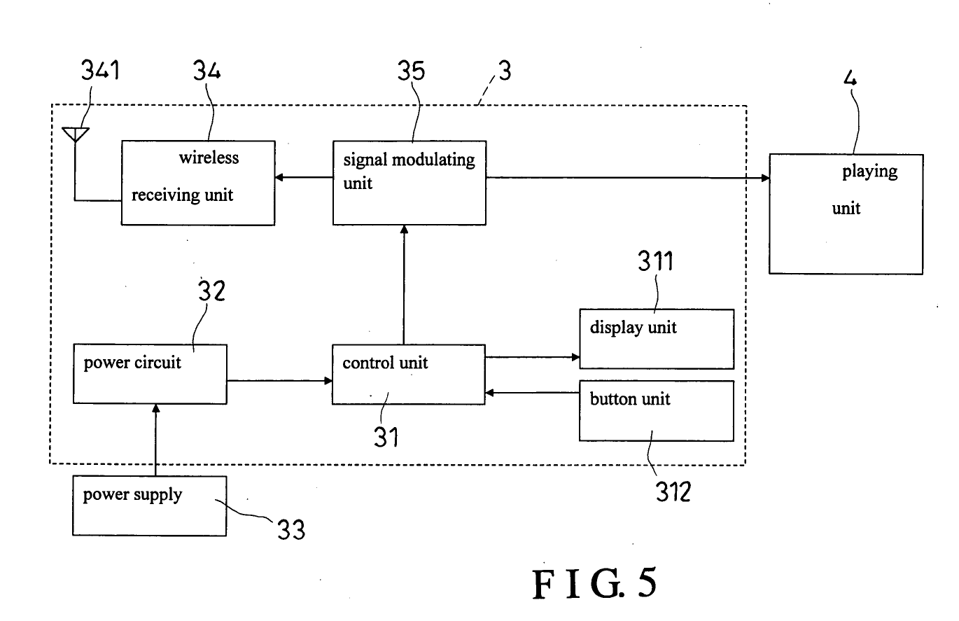

### DETAILED DESCRIPTION OF THE PREFERRED EMBODIMENTS

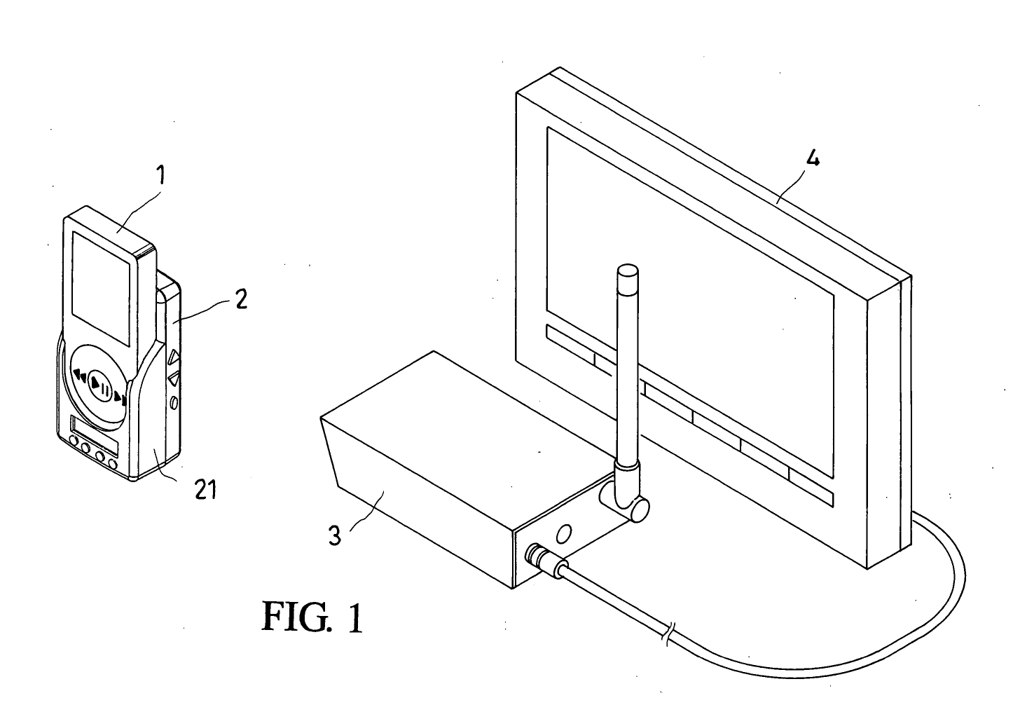

Referring to FIG. 1, a preferred embodiment of a multimedia video and audio wireless transmitting and receiving device of the present invention includes a transmitting equipment 2 for connection with a portable multimedia player 1, and a receiving equipment 3 for connection with a playing unit 4.

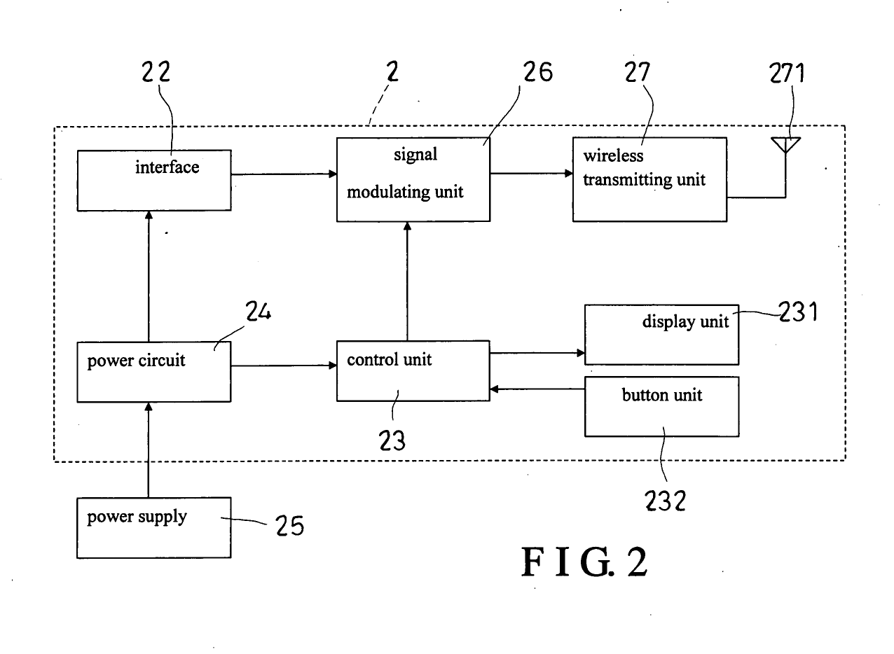

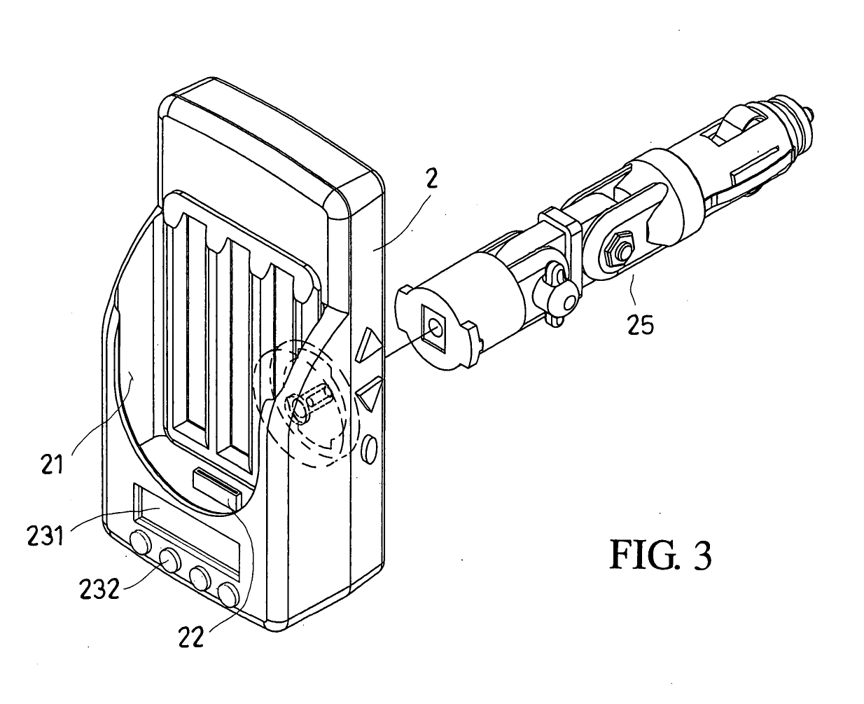

Referring to FIGS. 2 and 3, the transmitting equipment 2 includes:

a holding member 21 for the portable multimedia player 1 to be inserted in;

an interface 22 positioned in the holding member 21 for connection with the portable multimedia player 1 inserted in the holding member 21;

a control unit 23 therein, the control unit 23 has a button unit 232 and a display unit 231 connected thereto, which are used for operating the control unit 23, and for showing the condition of operation respectively;

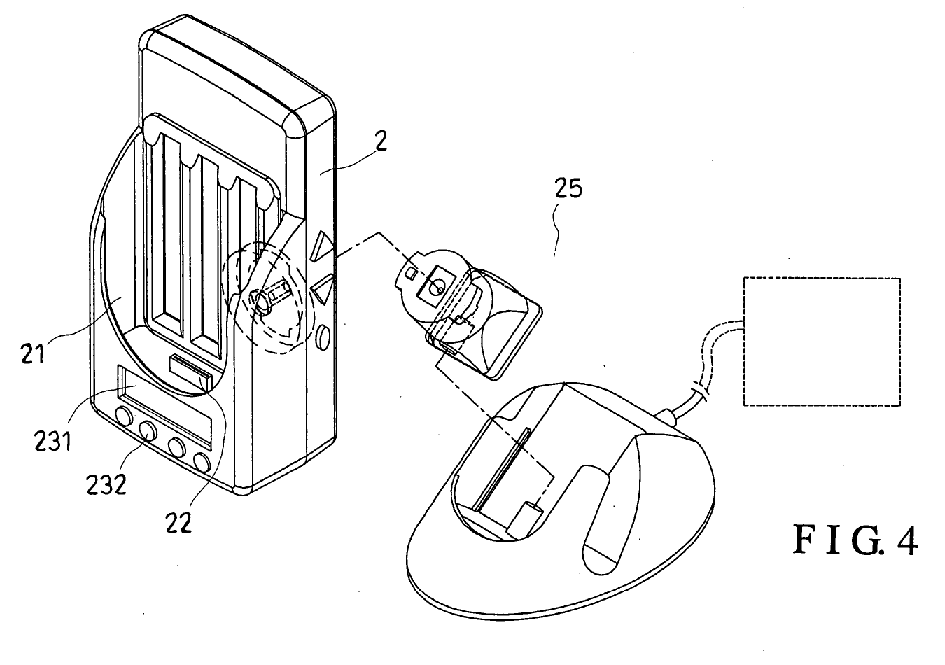

a power circuit 24 connected to the control unit 23, the power circuit 24 is to be connected to a power supply 25, which can be a car cigarette lighter (FIG. 3), batteries or utility grid (FIG. 4);

a signal modulating unit 26 connected to the control unit 23 as well as the interface 22; and

a wireless transmitting unit 27 connected to the signal modulating unit 26 as well as the control unit 23; the wireless transmitting unit 27 has an antenna 271.

Referring to FIG. 3, the receiving equipment 3 includes:

a control unit 31, the control unit 31 has a button unit 312 and a display unit 311 connected thereto, which are used for operating the control unit 31, and for showing the condition of operation respectively;

a power circuit 32 connected to the control unit 31, the power circuit 32 is to be connected to a power supply 33, which can be a car cigarette lighter, batteries or utility grid;

a wireless receiving unit 34 connected to the control unit 31; the wireless receiving unit 34 has an antenna 341 for receiving signals transmitted through the antenna 271 by the wireless transmitting unit 27 of the transmitting equipment 2; and

a signal modulating unit 35 connected to both the control unit 31 and the wireless receiving unit 34, the signal modulating unit 35 is to be connected to a playing unit 4, which has a display having larger dimensions than the display of the portable multimedia player, e.g. TV, and car TV.

To use the multimedia video and audio wireless transmitting and receiving device together with the portable multimedia player 1 and the receiving equipment 3, the portable multimedia player 1 is inserted in the holding member 21, and connected to the interface 22; thus, video and audio data in the portable multimedia player 1 are modulated by means of the signal modulating unit 26 of the transmitting equipment 2, transmitted through the antenna 271 by means of the wireless transmitting unit 27, received through the antenna 341 by means of the wireless receiving unit 34 of the receiving equipment 3, modulated by means of the signal modulating unit 35, and played through the playing unit 4.

Because the playing unit has larger dimensions than the display of portable multimedia player, the images will be larger and more clearly seen, and can be shared among several persons when video and audio data in the portable multimedia player are played through the playing unit with the help of the multimedia video and audio wireless transmitting and receiving device of the present invention.

What is claimed is:

1. A multimedia video and audio wireless transmitting and receiving device, comprising
(a) a transmitting equipment for connection with a portable multimedia player, said transmitting equipment including:
a holding member for a portable multimedia player to be inserted in;
an interface in said holding member for connection with a portable multimedia player inserted in said holding member;
a first control unit therein, said first control unit having a button unit and a display unit connected thereto, which are used for operation, and for showing condition of operation respectively;
a power circuit connected to said first control unit for connection with a power supply;
a signal modulating unit connected to said first control unit as well as said interface; and
a wireless transmitting unit connected to said signal modulating unit as well as said first control unit; said wireless transmitting unit having an antenna; and
(b) a receiving equipment for connection to a playing unit; said receiving equipment including:
a second control unit, said second control unit having a button unit and a display unit connected thereto, which are used for operation, and for showing condition of operation respectively;
a power circuit connected to said second control unit for connection with a power supply;
a wireless receiving unit connected to said second control unit; said wireless receiving unit having an antenna for receiving signals transmitted through said antenna of said wireless transmitting unit of said transmitting equipment; and
a signal modulating unit connected to both said second control unit and said wireless receiving unit, said signal modulating unit being connected to said playing unit used for playing video and audio signals received through said receiving equipment.
